(19) United States
(12) Patent Application Publication
(10) Pub. No.: US 2026/0322431 A1
(43) Pub. Date: Oct. 15, 2026

(54) WIRELESS COMMUNICATION SYSTEM, WIRELESS COMMUNICATION DEVICE, WIRELESS COMMUNICATION METHOD, AND WIRELESS COMMUNICATION PROGRAM

(71) Applicant: NTT, Inc., Tokyo (JP)

(72) Inventors: Daisuke GOTO, Musashino-shi, Tokyo (JP); Fumihiro YAMASHITA, Musashino-shi, Tokyo (JP); Kiyohiko ITOKAWA, Musashino-shi, Tokyo (JP); Koyo TATEGAMI, Musashino-shi, Tokyo (JP); Takeshi ONIZAWA, Musashino-shi, Tokyo (JP)

(73) Assignee: NTT, Inc., Tokyo (JP)

(21) Appl. No.: 19/484,923

(22) PCT Filed: Jun. 2, 2023
(86) PCT No.: PCT/JP2023/020681

§ 371 Date: Nov. 17, 2025

(51) Int. Cl. H04B 7/0413

(52) U.S. Cl. CPC H04B 7/0413

(57) ABSTRACT

A transmission station transmits a radio signal via a plurality of antennas to establish wireless communication by MIMO under a communication standard supporting a dummy frame. A UW unique to an antenna used for transmission of the dummy frame is imparted to the dummy frame. The dummy frame and a normal frame in which data to be transferred is stored are transmitted from any of the plurality of antennas. A reception station receives the dummy frame, extracts the UW, specifies the antenna of the transmission source of the dummy frame based on the UW, estimates a channel state between the transmission station and the reception station based on the reception state of the dummy frame the antenna of the transmission source of which can be specified, and achieves MIMO transmission for the data stored in the normal frame using a channel matrix representing the channel state.

### TECHNICAL FIELD

This disclosure relates to a wireless communication system, a wireless communication device, a wireless communication method, and a wireless communication program, and more particularly, to a wireless communication system, a wireless communication device, a wireless communication method, and a wireless communication program suitable for achieving MIMO transmission by diverting a communication standard that does not support MIMO.

### BACKGROUND ART

Non Patent Literature 1 below proposes utilizing a multiple input multiple output (MIMO) technology when performing wireless communication between a satellite and a ground base station. In the MIMO technology, a plurality of antennas is disposed on at least one of a transmission side and a reception side, and spatial multiplexing transmission of radio signals is performed. With this technology, the communication capacity can be greatly expanded as compared with a case where wireless communication using a pair of antennas is performed between the transmission side and the reception side.

Non Patent Literature 2 below discloses specifications of DVB-S2X known as a highly versatile standard in the field of wireless communication utilizing a satellite. DVB-S2X is a standard provided on the assumption of a single carrier, and its format is not designed on the assumption of MIMO transmission.

In addition, Non Patent Literature 3 below provides a technical description regarding MIMO technology. Here, specifically, it is disclosed that, in a case where a line-of-sight environment is established between two as in the relationship between the satellite and the ground base station, the arrangement of antennas is an important factor in improving the transmission capacity.

### CITATION LIST

### Non Patent Literature

Non Patent Literature 1: A. Knopp, R. T. Schwarz, D. Ogermann, C. A. Hofmann and B. Lankl, “Satellite System Design Examples for Maximum MIMO Spectral Efficiency in LOS Channels,” IEEE GLOBECOM 2008-2008 IEEE Global Telecommunications Conference, 2008, pp. 1-6.
Non Patent Literature 2: ETSI, ETSI. “ETSI: EN 302 307-2 Digital Video Broadcasting (DVB).” Second generation framing structure, channel coding and modulation systems for Broadcasting, Interactive Services, News Gathering and other broadband satellite applications Part II: S2-Extensions (DVB-S2X) (2014): 13-24.
Non Patent Literature 3: Kim, Joonsuk, and Inkyu Lee. “802.11 WLAN: history and new enabling MIMO techniques for next generation standards.” IEEE Communications Magazine 53.3 (2015): 134-140.

### SUMMARY OF INVENTION

### Technical Problem

Meanwhile, in order to achieve MIMO transmission between a transmission station and a reception station, it is necessary to estimate channel components formed between the transmission station and the reception station. In addition, in order to transmit radio signals from a plurality of antennas and identify the signals on the reception side, it is also necessary to synchronize the individual signals.

In order to enable estimation of channel components and the above synchronization, it is necessary to identify each of the radio signals transmitted from the plurality of antennas. In addition, in order to enable such identification, it is necessary to include information contributing to the identification of the signals in the individual signals. On the other hand, in the above-described standard such as DVB-S2X, since MIMO transmission is not assumed, a format for exchanging such information is not prepared. For this reason, it has been difficult to achieve MIMO transmission using a highly versatile standard.

In order to solve the above problem, a first object of the present disclosure is to provide a wireless communication system that enables MIMO transmission under a standard that does not assume MIMO transmission by appropriately utilizing a rule of the standard.

In addition, a second object of the present disclosure is to provide a wireless communication device that enables MIMO transmission under a standard that does not assume MIMO transmission by appropriately utilizing a rule of the standard.

In addition, a third object of the present disclosure is to provide a wireless communication method that enables MIMO transmission under a standard that does not assume MIMO transmission by appropriately utilizing a rule of the standard.

In addition, a fourth object of the present disclosure is to provide a wireless communication program that enables MIMO transmission under a standard that does not assume MIMO transmission by appropriately utilizing a rule of the standard.

### Solution to Problem

In order to achieve the above object, a first aspect is desirably a wireless communication system in which a transmission station and a reception station perform spatial multiplexing transmission of a plurality of signals, wherein
the transmission station is configured to execute
processing of transmitting a dummy signal not including data to be transmitted by the wireless communication system,
processing of imparting different unique information to each of dummy signals transmitted as each of the plurality of signals, and
processing of repeatedly transmitting the dummy signal, and
the reception station is configured to execute
processing of receiving the plurality of signals,
processing of extracting the unique information included in the dummy signal from a reception signal, and
processing of acquiring reception information of each of the plurality of signals transmitted and received by the spatial multiplexing transmission based on the extracted unique information.

In addition, a second aspect is desirably a wireless communication device including a function of a transmission station and a function of a reception station and performing spatial multiplexing transmission of a plurality of signals with respect to a communication destination wireless communication device, wherein
the transmission station is configured to execute
processing of transmitting a dummy signal not including data needed to be transmitted beyond the communication destination wireless communication device,
processing of imparting different unique information to each of dummy signals transmitted as each of the plurality of signals, and
processing of repeatedly transmitting the dummy signal, and
the reception station is configured to execute
processing of receiving the plurality of signals transmitted from the communication destination wireless communication device by spatial multiplexing transmission,
processing of extracting the unique information included in the dummy signal from a reception signal, and
processing of acquiring reception information of each of the plurality of signals transmitted and received by the spatial multiplexing transmission based on the extracted unique information.

In addition, a third aspect is desirably a wireless communication method for a transmission station and a reception station to perform spatial multiplexing transmission of a plurality of signals, the wireless communication method including:
by the transmission station,
transmitting a dummy signal not including data needed to be transmitted beyond the reception station,
imparting different unique information to each of dummy signals transmitted as each of the plurality of signals, and
repeatedly transmitting the dummy signal, and
by the reception station,
receiving the plurality of signals,
extracting the unique information included in the dummy signal from a reception signal, and
acquiring reception information of each of the plurality of signals transmitted and received by the spatial multiplexing transmission based on the extracted unique information.

In addition, a fourth aspect is desirably a wireless communication program for causing a wireless communication device including a function of a transmission station and a function of a reception station to perform spatial multiplexing transmission of a plurality of signals with respect to a communication destination wireless communication device, the wireless communication program including:
a computer-readable program causing the wireless communication device to execute as the transmission station
processing of transmitting a dummy signal not including data needed to be transmitted beyond the communication destination wireless communication device,
processing of imparting different unique information to each of dummy signals transmitted as each of the plurality of signals, and
processing of repeatedly transmitting the dummy signal, and
a computer-readable program causing the wireless communication device to execute as the reception station
processing of receiving the plurality of signals transmitted from the communication destination wireless communication device by spatial multiplexing transmission,
processing of extracting the unique information included in the dummy signal from a reception signal, and
processing of acquiring reception information of each of the plurality of signals transmitted and received by the spatial multiplexing transmission based on the extracted unique information.

### Advantageous Effects of Invention

According to the first to fourth aspects, even in a case where a standard that does not assume spatial multiplexing transmission is used, it is possible to achieve spatial multiplexing transmission under the standard by appropriately utilizing a dummy frame.

### BRIEF DESCRIPTION OF DRAWINGS

FIG. 1 is a diagram illustrating a configuration in a case where a wireless communication system according to a first embodiment of the present disclosure is achieved by using a satellite and a ground base station;

FIG. 2 is a diagram illustrating a generalized configuration of the first embodiment of the present disclosure by replacing the satellite illustrated in FIG. 1 with a mobile station;

FIG. 3 is a block diagram for functionally describing configurations of a mobile station and a ground base station illustrated in FIG. 2;

FIG. 4 is a diagram for describing a structure of a PL frame used under the DVB-S2X standard used in the first embodiment of the present disclosure;

FIG. 5 is a diagram for describing a pattern of a radio signal repeatedly transmitted from a transmission station to a reception station in the first embodiment of the present disclosure;

FIG. 6 is a diagram for describing details of a dummy frame included in the pattern illustrated in FIG. 5;

FIG. 7 is a block diagram for describing characteristic functions of the reception station in the first embodiment of the present disclosure;

FIG. 8 is a flowchart for describing a flow of processing executed in the first embodiment of the present disclosure;

FIG. 9 is a flowchart for describing a flow of a modification of processing illustrated in FIG. 8;

FIG. 10 is a block diagram for describing characteristic functions of a ground base station included in a second embodiment of the present disclosure; and

FIG. 11 is a diagram for describing a problem to be solved by the second embodiment of the present disclosure.

### DESCRIPTION OF EMBODIMENTS

### First Embodiment

### [Configuration of First Embodiment]

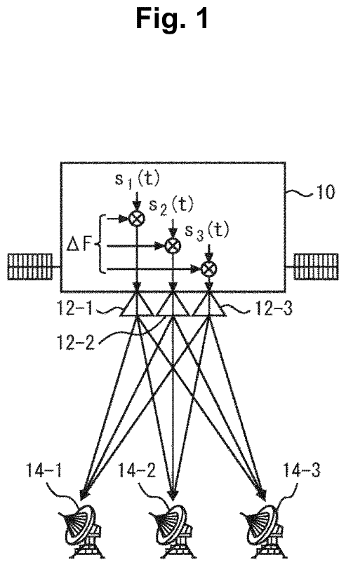

FIG. 1 illustrates a configuration in a case where a wireless communication system according to a first embodiment of the present disclosure is achieved by using a satellite and a ground base station. As illustrated in FIG. 1, the system of the present embodiment includes a satellite 10. The satellite 10 includes a plurality of antennas. FIG. 1 illustrates a state in which the satellite 10 includes three antennas 12-1 to 12-3. Hereinafter, in a case where it is not necessary to distinguish them, they are referred to as “antennas 12” by omitting reference signs of suffixes.

The system of the present embodiment also includes one or more ground antennas. FIG. 1 specifically illustrates an example in which the system of the present embodiment includes three ground antennas 14-1 to 14-3. Hereinafter, when it is not necessary to distinguish them from each other, the reference signs of the suffixes are omitted and the ground antennas are referred to as “ground antennas 14”.

The satellite 10 illustrated in FIG. 1 may be a LEO satellite. The LEO satellite, for example, orbits in a low Earth orbit (LEO), which is an orbit around the Earth at an altitude of less than 2,000 km. The LEO is closer to the Earth's surface than a geostationary earth orbit (GEO). Therefore, the communication system using the LEO satellite can enjoy various advantages.

Specifically, the distance between the LEO satellite and the ground antennas 14 is 1/10 or less as compared with the case of using a GEO satellite. Therefore, in the system using the LEO satellite, the propagation delay can be significantly reduced as compared with the system using the GEO satellite. In addition, since the propagation distance is small, the propagation loss is also small. Therefore, it is possible to reduce the power consumption of the transmission station, downsize the transmission station and the ground station, and the like, and it is possible to expect a reduction in equipment cost.

Note that the LEO satellite is different from the GEO satellite in that the LEO satellite is characterized by constantly moving as seen from the ground. For this reason, in order to always deploy the service using the LEO satellite, it is necessary to launch a plurality of satellites to deploy the coverage throughout the entire service area. In particular, in order to deploy a global service, it is essential to deploy a satellite constellation in earth orbit.

In addition, in a service using the LEO satellite, in a case where it is desired to increase the communication capacity of a ground terminal or in a case where the number of accommodated terminals is increased, it is also necessary to increase the capacity of the line of a feeder link for exchanging communication data between the satellite and the base station. In order to increase the capacity, it is desirable to use a high frequency band capable of performing communication in a wide band. In particular, in the field of satellite communication, utilization of the Ka band of 20 to 30 GHz band and the Q/V band of 40 to 50 GHz band has been studied. Since the effect of rain attenuation is large in these bands, it is necessary for the communication system to be constructed so as to allow the occurrence of communication interruption at the time of rain. As a countermeasure against rainfall, for example, a method of site diversity in which a plurality of antennas is remotely disposed and used has been studied.

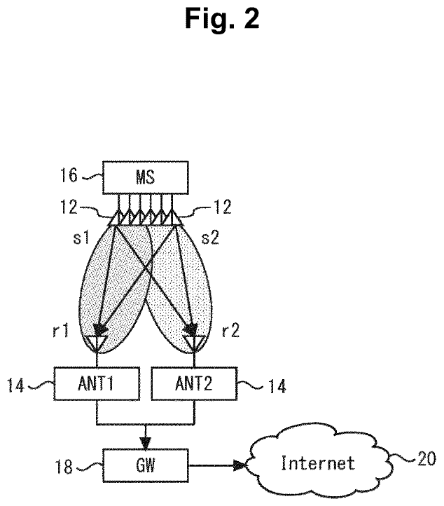

FIG. 2 illustrates a diagram illustrating a generalized configuration of the first embodiment of the present disclosure in which the satellite 10 illustrated in FIG. 1 is replaced with a mobile station (hereinafter, referred to as a moving station: “MS”) 16. The MS 16 can be any mobile station having a communication function including a high altitude platform station (HAPS) that flies at an altitude of about 20 km from the ground in addition to the above-described LEO satellite.

The MS 16 illustrated in FIG. 2 includes a plurality of antennas 12 similarly to the satellite 10 illustrated in FIG. 1. The MS 16 can individually transmit different signals from the plurality of antennas 12, respectively. FIG. 2 illustrates a state in which these antennas 12 send signals S1 and S2.

In the example illustrated in FIG. 2, two ground antennas 14 communicate with the MS 16. Here, the ground antenna 14 illustrated on the left side in the drawing is referred to as ANT1, and the ground antenna 14 illustrated on the right side in the drawing is referred to as ANT2. In addition, a signal received by the ANT1 is referred to as signal r1, and a signal received by the ANT2 is referred to as r2. The ANT1 and the ANT2 can transmit the received signals r1 and r2 to a ground base station (hereinafter, referred to as a gate way: “GW”) 18, respectively. After performing processing such as decoding on the signals r1 and r2, the GW 18 can send the signals r1 and r2 to an Internet line 20.

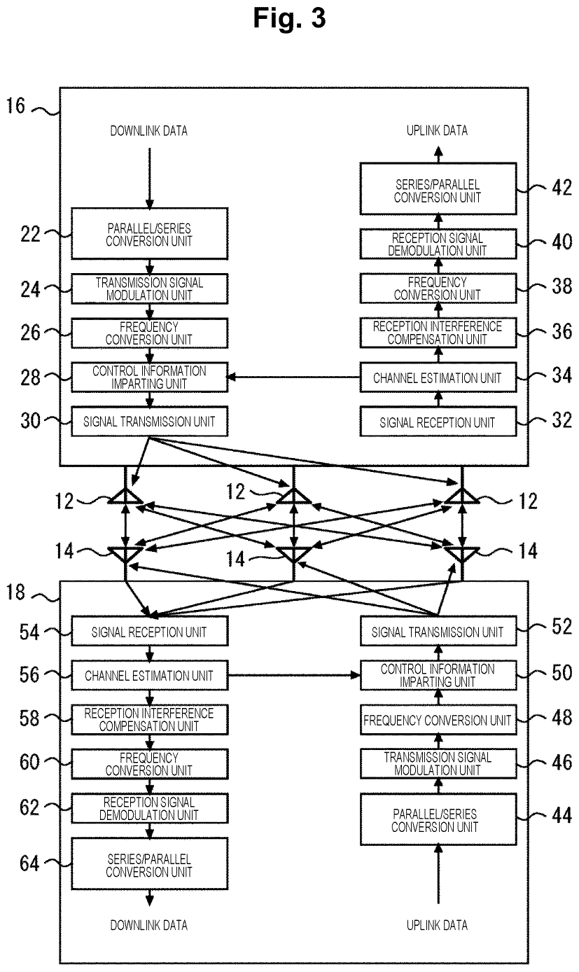

FIG. 3 is a block diagram for functionally describing the configurations of the MS 16 and the GW 18.

As illustrated in FIG. 3, the MS 16 has the blocks described below to process downlink data to be transmitted toward the GW 18.

“Parallel/series conversion unit 22”: A block that performs parallel/series conversion on bit information of downlink data. The number of the parallel is set to the number of connections of a communication target that is the transmission source of the downlink data. It is assumed that the number of connections is provided to the MS 16 as control information.

“Transmission signal modulation unit 24”: A block that modulates a bit string and converts the bit string into an electrical signal.

“Frequency conversion unit 26”: A block that converts an electrical signal into a predetermined frequency to be given to a radio signal sent from the antenna 12.

“Control information imparting unit 28”: A block that imparts presence or absence of transmission/reception interference to control information. The presence or absence of transmission/reception interference is determined on the basis of a channel state estimated by a channel estimation unit 34 described below.

“Signal transmission unit 30”: A block for transmitting a received signal from the antenna 12.

In addition, the MS 16 has the blocks described below to process uplink data transmitted from the GW 18.

“Signal reception unit 32”: A block for receiving a signal reaching the antenna 12. When signals are sent from the plurality of ground antennas 14 to the individual antennas 12 at overlapping timings, the signals may reach the antenna 12 of the MS 16 while interfering with each other. In this case, the signal reception unit 32 also performs processing for synchronizing these signals.

“Channel estimation unit 34”: Estimating the state of a channel formed between the antenna 12 of the MS 16 and the ground antenna 14 based on a signal received by the signal reception unit 32. The estimated channel state is provided to the control information imparting unit 28 as described above.

“Reception interference compensation unit 36”: A block that executes reception interference compensation for separating signals sent from the plurality of ground antennas 14 when the signals reach the antenna 12 while interfering with each other. The reception interference compensation is executed on the basis of the channel state estimated by the channel estimation unit 34.

“Frequency conversion unit 38”: A block for converting a radio signal in a state in which an effect of reception interference is compensated into an electrical signal of a predetermined frequency.

“Reception signal demodulation unit 40”: A block that demodulates an electrical signal into a bit string.

“Series/parallel conversion unit 42”: A block that generates uplink data by performing series/parallel conversion on an electrical signal demodulated into a bit string. The number of the parallel is set to the number of connections of a communication target that is the transmission destination of the uplink data. As in the case of the parallel/series conversion unit 22, the number of connections is provided to the MS 16 as control information.

The GW 18 has the blocks described below to process uplink data transmitted toward the MS 16.

“Parallel/series conversion unit 44”: A block that performs parallel/series conversion on bit information of uplink data. The number of the parallel is set to the number of connections of a communication target that is the transmission source of the uplink data. This number of connections is provided to the GW 18 as control information.

“Transmission signal modulation unit 46”: A block that modulates a bit string and converts the bit string into an electrical signal.

“Frequency conversion unit 48”: A block that converts an electrical signal into a predetermined frequency to be given to a radio signal sent from the ground antenna 14.

“Control information imparting unit 50”: A block that imparts presence or absence of transmission/reception interference to control information. The presence or absence of transmission/reception interference is determined on the basis of a channel state estimated by a channel estimation unit 56 described below.

“Signal transmission unit 52”: A block for transmitting a received signal from the ground antenna 14.

The GW 18 also has the blocks described below to process downlink data transmitted from the MS 16.

“Signal reception unit 54”: A block for receiving a signal reaching the ground antenna 14. In a case where the signals sent from the plurality of antennas 12 reach the ground antennas 14 while interfering with each other, the signal reception unit 54 also executes processing for synchronizing the signals.

“Channel estimation unit 56”: Estimating the channel state between the antenna 12 of the MS 16 and the ground antenna 14 based on a signal received by the signal reception unit 54.

“Reception interference compensation unit 58”: Executing reception interference compensation for separating signals sent from the plurality of antennas 12 in a case where the signals reach the ground antenna 14 while interfering with each other.

“Frequency conversion unit 60”: A block for converting a radio signal in a state in which an effect of reception interference is compensated into an electrical signal of a predetermined frequency.

“Reception signal demodulation unit 62”: A block that demodulates an electrical signal into a bit string.

“Series/parallel conversion unit 64”: A block that generates downlink data by performing series/parallel conversion on an electrical signal demodulated into a bit string. The number of the parallel is set to the number of connections of a communication target that is the transmission destination of the downlink data. As in the case of the parallel/series conversion unit 44, the number of connections is provided to the GW 18 as control information.

Each of the configuration of the MS 16 and the configuration of the GW 18 described above can be achieved by a combination of dedicated hardware and a general computer system. The computer system includes a processor typically represented by a CPU, a memory device including ROM, RAM, a hard disk, and the like, and various interface devices. The functions of the MS 16 and the functions of the GW 18 are achieved by executing programs stored in the respective memory devices by the respective processors.

### [Feature of First Embodiment]

In the present embodiment, wireless communication by MIMO transmission using the plurality of antennas 12 and the plurality of ground antennas 14 is established between the MS 16 and the GW 18. In addition, in the present embodiment, the MS 16 and the GW 18 achieve the above functions by diverting a communication standard that does not support MIMO transmission. Specifically, the MS 16 and the GW 18 achieve MIMO transmission under the DVB-S2X standard recognized as having high versatility in the field of satellite communication and the like.

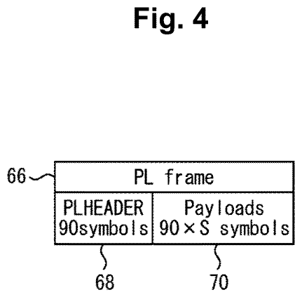

FIG. 4 illustrates a structure of a communication frame supported by the DVB-S2X standard. Hereinafter, this frame is referred to as a “PL frame 66”. As illustrated in FIG. 4, the PL frame 66 includes a PL header 68 and a payload 70. The PL header 68 includes 90 symbols. In addition, the payload 70 includes 90×S symbols.

For example, a symbol indicating that the frame is a “dummy” can be stored and used in the PL header 68. Hereinafter, such a frame is referred to as a “dummy frame”. On the other hand, a frame including a symbol that is not “dummy” in the PL header 68 is referred to as a “normal frame”. In the DVB-S2X standard, the normal frame is treated as a frame in which data to be exchanged is stored in the payload 70. On the other hand, the dummy frame is treated as a frame in which data to be exchanged is not stored in the payload 70. As a result, the dummy frame is processed in the channel estimation unit 56 and then discarded without being subject to demodulation or the like.

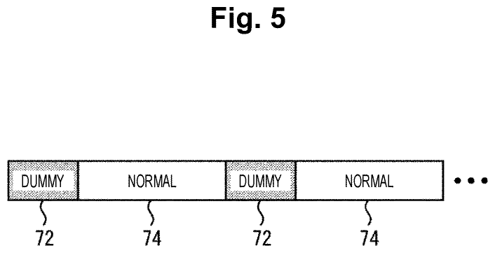

FIG. 5 illustrates a repetitive pattern of a radio signal transmitted from the MS 16 toward the GW 18 to achieve MIMO transmission in the present embodiment. As illustrated in FIG. 5, in the present embodiment, a dummy frame 72 and a normal frame 74 are alternately and repeatedly transmitted from the MS 16 to the GW 18. Note that the repetitive pattern illustrated in FIG. 5 is also used in a radio signal transmitted from the GW 18 to the MS 16 for MIMO transmission.

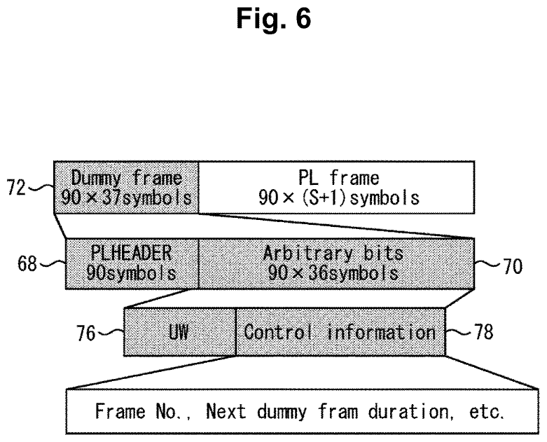

FIG. 6 is a diagram for describing details of the dummy frame 72. The dummy frame 72 is also a type of the PL frame 66 conforming to the DVB-S2X standard. Therefore, the dummy frame 72 also includes a PL header 68 including 90 symbols and a payload 70 including 90×S (specifically, 90×37) arbitrary bit symbols.

Then, in the PL header 68 of the dummy frame 72, a prescribed symbol defined as “dummy” by the DVB-S2X standard is stored. On the other hand, in the present embodiment, a unique word (hereinafter, “UW”) 76 unique to the antenna 12 of the transmission source and control information 78 are stored in the payload 70 (arbitrary bit symbol) of the dummy frame 72.

The control information 78 can include a frame number, a period until the next dummy frame, and the like. In addition, in the present embodiment, the MS 16 serving as a communication counterpart of the ground antenna 14 is switched over time as the MS 16 moves. The control information 78 can also include information regarding a combination of the MS 16 and the ground antenna 14 in communication, and information regarding a channel state between them.

### [Use of Orthogonal Code]

In the present embodiment, to the arbitrary bit symbol of the dummy frame 72, that is, the UW 76 and the control information 78 described above, a signal that is unique for each antenna 12 of the transmission source and has an orthogonal relationship with a signal unique to another antenna 12 is given. Specifically, orthogonal codes such as a gold sequence and a walsh code are assigned to the UW 76 and the control information 78.

As long as the arbitrary bit symbol includes an orthogonal code, even in a state where a plurality of signal components interferes with each other, individual components can be extracted or estimated by executing peak value detection using a correlator. For example, even in a situation where the MS 16 simultaneously transmits signals from the plurality of antennas 12 and they reach the ground antennas 14 while interfering with each other, the GW 18 can individually extract the UW 76 and the control information 78. Then, when the UW 76 can be extracted, it can be determined from which of the plurality of antennas 12 the dummy frame 72 including the symbol has been sent.

In the present embodiment, the GW 18 detects a timing error when the signals sent from the individual antennas 12 reach the individual ground antennas 14 on the basis of the information extracted in this manner, and achieves synchronization between the signals on the basis of the result. In addition, the GW 18 can also detect a frequency error by detecting the phase deviation of the UW 76. Thus, the GW 18 can also achieve frequency synchronization.

In addition, an output value of the correlator described above used for obtaining the correlation with the orthogonal code also indicates a channel state between the antenna 12 and the ground antenna 14. Therefore, the output value of the correlator can be used as a channel estimation value. Therefore, in the present embodiment, the GW 18 can estimate the channel state between the antenna 12 and the ground antenna 14 by analyzing the dummy frame.

In addition, in the present embodiment, as described above, in addition to the UW 76, the control information 78 is imparted to the arbitrary bit symbol of the dummy frame 72. Then, the control information 78 includes the frame number and the period until the next dummy frame as described above. By using the frame number, it is possible to correct an error of the reception timing exceeding the frame length allowed by the GW 18 that is a reception station. In addition, when the time until the next dummy frame is known, the detection accuracy of the next dummy frame can be enhanced. Therefore, with the system of the present embodiment, the reception characteristics of the GW 18 can be improved.

Note that, in the above example, it is possible to extract individual signal components from the interference signals by orthogonalizing the UW 76 and the like, but the method is not limited thereto. For example, the sending timing from individual antennas 12 may be divided along the time axis, and while one antenna 12 is transmitting the dummy frame 72, the other antennas 12 may be put into a stopped state to detect a specific UW 76 and the like one by one. Alternatively, signals from the plurality of antennas 12 may be divided along the frequency axis and made orthogonal.

### [Operation of First Embodiment]

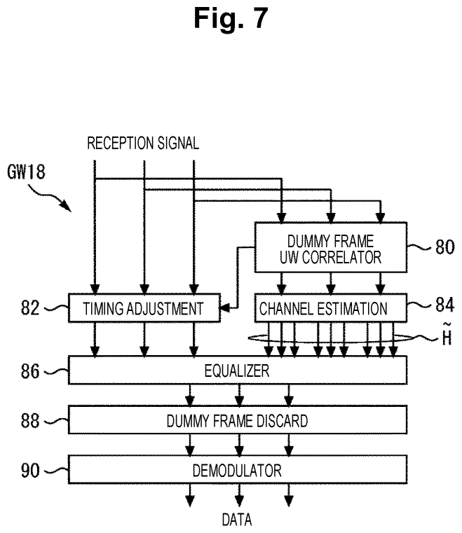

FIG. 7 is a block diagram for describing characteristic functions of the reception station side of MIMO transmission. Here, a case where the MS 16 is a transmission station and the GW 18 is a reception station will be described as an example. That is, the description will be given assuming that FIG. 7 is a block diagram of the GW 18.

The signals (for example, r1 to r3) respectively received by the plurality of ground antennas 14 (for example, 14-1 to 14-3) are collected in the GW 18. The signals (for example, r1 to r3) sent from the plurality of antennas 12 (for example, 12-1 to 12-3) on the MS 16 side may reach the ground antennas 14 while interfering with each other. Therefore, each of the reception signals (r1 to r3) may include components of the plurality of transmission signals (s1 to s3) in a superimposed manner. Such reception signals are transmitted to the GW 18 from the plurality of ground antennas 14.

The reception signals (r1 to r3) collected into the GW 18 are provided to a dummy frame UW correlator 80 and a timing adjuster 82. These are formed inside the signal reception unit 54 in the block diagram illustrated in FIG. 3.

In the dummy frame UW correlator 80, peak value detection by the correlator is executed for the reception signals (r1 to r3). When the transmission signals (s1 to s3) include a dummy frame, the signal components included in the transmission signals (s1 to s3), that is, the UW 76 and the control information 78 are extracted or estimated from the reception signals (r1 to r3).

The processing result of the dummy frame UW correlator 80 is provided to the timing adjuster 82. The timing adjuster 82 performs timing adjustment of the reception signals using the result of the processing by the dummy frame UW correlator 80.

The output value of the dummy frame UW correlator 80 is also provided to a channel estimator 84. The channel estimator 84 corresponds to the channel estimation unit 56 in the block diagram illustrated in FIG. 3. The output value of the correlator can be used as a channel estimation value as described above. Then, the channel estimator 84 generates a channel matrix H representing the state of the channel between the antenna 12 and the ground antenna 14 on the basis of the output value, that is, the channel estimation value. The information of the generated channel matrix H is provided to an equalizer 86 together with the reception signal processed by the timing adjuster 82.

The equalizer 86 corresponds to the reception interference compensation unit 58 in the block diagram illustrated in FIG. 3. The above-described channel matrix H is a matrix for extracting individual transmission signals (s1 to s3) by being multiplied by the reception signals (r1 to r3) including the components of the plurality of transmission signals (s1 to s3). The equalizer 86 performs reception interference compensation using the channel matrix H on the reception signals (r1 to r3) having passed through the timing adjuster 82, and acquires separated transmission signals (s1 to s3). Hereinafter, this processing is referred to as “equalization processing”.

The equalization processing described above is performed using the channel matrix H based on the output value of the dummy frame UW correlator 80. At the time point when the normal frame 74 is received following the dummy frame 72, the channel matrix H based on the dummy frame 72 received immediately before is obtained. Therefore, the equalizer 86 can also perform the equalization processing on the normal frame using the channel matrix H.

In the present embodiment, due to the movement of the MS 16, the state of the channel between the antenna 12 and the ground antenna 14 changes from moment to moment. Under such a situation, after the channel matrix H is acquired, the actual state of the channel deviates from the state represented by the channel matrix H with the lapse of time. On the other hand, in the present embodiment, the equalization processing of the normal frame 74 is performed on the basis of the channel matrix H acquired on the basis of the immediately preceding dummy frame 72. In this case, since the time difference between the timing of the acquisition of the channel matrix H and the execution timing of the equalization processing is extremely small, highly accurate equalization processing can be performed on the normal frame 74. Therefore, according to the present embodiment, extremely accurate MIMO transmission can be achieved while using a communication standard that does not support MIMO transmission.

As illustrated in FIG. 7, the signal processed by the equalizer 86 is provided to a dummy frame discarder 88. The function of the dummy frame discarder 88 is a function supported by the DVB-S2X standard used in the present embodiment. With this function, the frame to which a predetermined dummy header is attached is discarded as not including actual data. As a result, in the present embodiment, while the transmission and reception of the dummy frame 72 are repeated, unnecessary demodulation processing or the like for the dummy frame 72 can be inevitably avoided from being performed on the reception side.

On the other hand, the normal frame 74 passes through the dummy frame discarder 88 and is provided to a demodulator 90. Thereafter, the GW 18 performs processing necessary for generating the downlink data only for the normal frame 74. As a result, MIMO transmission with good communication quality is achieved without causing unnecessary arithmetic processing.

Note that the dummy frame discarder 88 and the demodulator 90 illustrated in FIG. 7 are functions built in an existing modem used under the DVB-S2X standard. In the block diagram illustrated in FIG. 3, they are formed inside the reception interference compensation unit 58, the frequency conversion unit 60, or the reception signal demodulation unit 62.

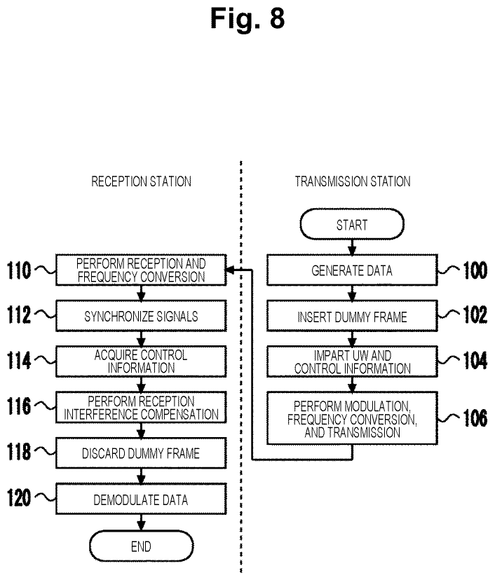

FIG. 8 is a flowchart for describing a flow of processing performed in each of the transmission station and the reception station in the present embodiment in order to achieve the above functions. Hereinafter, as in the description regarding FIG. 7, a case where the MS 16 is a transmission station and the GW 18 is a reception station will be described as an example.

When recognizing generation of downlink data to be transmitted to the GW 18 (step 100), the MS 16 that is a transmission station generates the normal frame 74 in which the data is stored in the payload 70.

Next, the dummy frame 72 is inserted in front of the normal frame 74 (step 102). In the PL header 68 of the dummy frame 72, a prescribed symbol meaning a dummy is stored.

Next, the UW 76 and the control information 78 are imparted to an arbitrary bit symbol of the dummy frame 72 (step 104). Which of the plurality of antennas 12 is set as the current transmission antenna is determined at this time point. Then, the UW 76 and the control information 78 include orthogonal codes unique to the antenna 12 used as a transmission antenna.

Thereafter, processing such as data modulation, frequency conversion, and transmission is sequentially performed, and the dummy frame 72 and the normal frame 74 are transmitted from the transmission antenna in this order (step 106).

The above processing may be executed in parallel for the plurality of antennas 12. That is, when there is only one piece of data to be transmitted, a radio signal is transmitted from only one antenna 12 by the above processing. On the other hand, when there is a plurality of pieces of data to be transmitted, a plurality of sets of radio signals may be simultaneously transmitted using the plurality of antennas 12 such that a set of the dummy frame 72 and the normal frame 74 is transmitted from individual antennas 12.

In the GW 18 that is a reception station, the transmission signals from the MS 16 are collected via the plurality of ground antennas 14. The GW 18 receives these signals and performs processing such as frequency conversion (step 110).

Next, the GW 18 performs peak value detection using a correlator on the received signals. Then, processing for synchronizing the signals is performed on the basis of the UW 76 extracted by the peak value detection (step 112).

Further, the GW 18 extracts the control information 78 included in the dummy frame 72 based on the result of the peak value detection (step 114).

In addition, the GW 18 acquires a channel estimation value from the output value of the peak value detection, and generates a channel matrix H representing the channel state at the current time point. Then, reception interference compensation for the reception signals is performed using the channel matrix H (step 116).

Thereafter, in the GW 18, the dummy frame is discarded (step 118), and processing such as data demodulation is executed only for the normal frame 74 (step 120).

As described above, in the present embodiment, communication by MIMO transmission is achieved by appropriately diverting a standard that does not support MIMO transmission. Therefore, according to the present embodiment, the MIMO transmission function can be implemented in a system using a highly versatile standard such as DVB-S2X.

### [Modification of First Embodiment]

Meanwhile, in the above example, a case where the MS 16 functions as a transmission station and the GW 18 functions as a reception station has been described. However, the present disclosure is not limited thereto. By the method of the present embodiment, it is also possible to cause the GW 18 to function as a transmission station and the MS 16 to function as a reception station.

In addition, in the first embodiment described above, a plurality of transmission signals from the transmission station interferes with each other and reaches the reception station, and the reception station performs reception interference compensation for separating these signals. However, in a case where the transmission station can grasp the channel state in advance, by performing precoding on the transmission signal, it is possible to cause the transmission signal without interference to reach each antenna on the reception side. In this case, MIMO transmission can be achieved in an aspect in which reception interference compensation by the reception station is unnecessary.

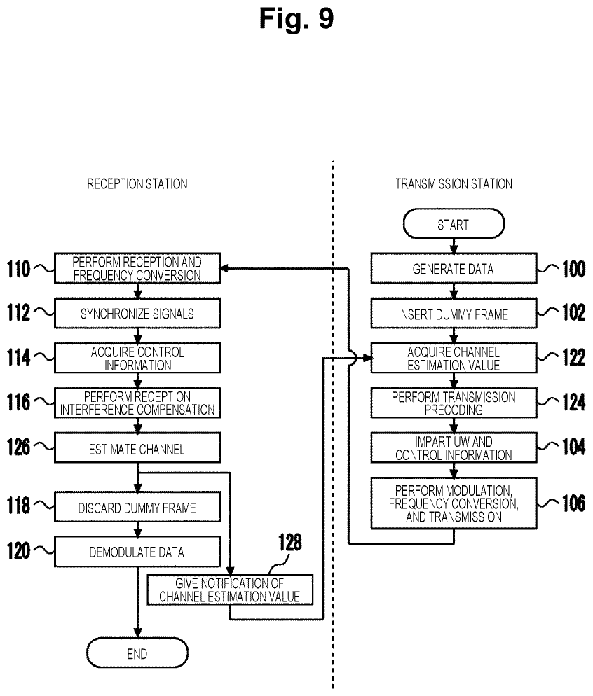

FIG. 9 is a flowchart for describing a flow of processing performed by each of the transmission station and the reception station to achieve MIMO transmission by the transmission precoding method. Note that the description described below will proceed with an example in which the MS 16 functions as a transmission station and the GW 18 functions as a reception station, similarly to the description of the flowchart illustrated in FIG. 8. In addition, in FIG. 9, the same steps as those illustrated in FIG. 8 are denoted by the same reference numerals, and the description thereof will be omitted or simplified.

According to the routine illustrated in FIG. 9, following the processing of step 102, the transmission station performs processing for acquiring a channel estimation value (step 122). When the reception station has already completed the channel estimation, a notification of the result is received from the reception station in this step 122. On the other hand, in a case where the reception station has not yet completed the channel estimation, a notification of the channel estimation cannot be received, and thus the processing proceeds to the next step.

In step 122 above, when the channel estimation value can be obtained, the channel matrix H corresponding to the channel estimation value is calculated. Then, the transmission signal is multiplied by a weight matrix W based on the channel matrix H to perform transmission precoding (step 124). When precoding is performed on the transmission signal, a transmission signal not affected by interference can reach each of the plurality of ground antennas 14.

On the other hand, in step 122 described above, when the channel estimation value has not been acquired, precoding cannot be performed on the transmission signal. Therefore, in this case, subsequently, through steps 104 and 106, a signal on which transmission precoding has not been performed is transmitted as in the case illustrated in FIG. 8.

When precoding is performed on the transmission signal, as described above, each of the plurality of ground antennas 14 receives a signal that is not affected by interference. In this case, the GW 18 executes the processing of steps 112 and 114 on the reception signals. Because reception interference compensation does not need to be performed, step 116 is jumped.

Subsequently to the above processing, the GW 18 performs channel estimation using the reception signal (step 126). A notification of the result of the channel estimation is given to the MS 16 that is a transmission station (step 128). A notification of this result may be directly given to the MS 16 by the GW 18, or may be given to the MS 16 via an external control station.

When precoding is not performed on the transmission signal, the processing of steps 110 to 116 is executed on the reception signal affected by interference as in the case illustrated in FIG. 8. Then, the processing of step 126 is executed using the signals whose individual signal components have been separated as a result of the reception interference compensation. This allows the transmission station to perform transmission precoding thereafter.

Note that, in the modification illustrated in FIG. 9, the channel estimation is always performed in the reception station, and the transmission station acquires the channel estimation value upon receiving a notification from the reception station. However, a method in which the transmission station obtains the channel estimation value is not limited thereto. For example, the channel estimation value may be acquired by the transmission station by the procedure described below.

(1) The dummy frame 72 to which an orthogonal code is imparted is transmitted from each of the plurality of ground antennas 14 toward the MS 16.

(2) The MS 16 extracts the transmission signal from each of the ground antennas 14 by performing peak value detection using the dummy frame UW correlator. Each extracted transmission signal is used as a pilot signal emitted from each of the plurality of ground antennas 14 to calculate a channel estimation value.

### Second Embodiment

### [Configuration of Second Embodiment]

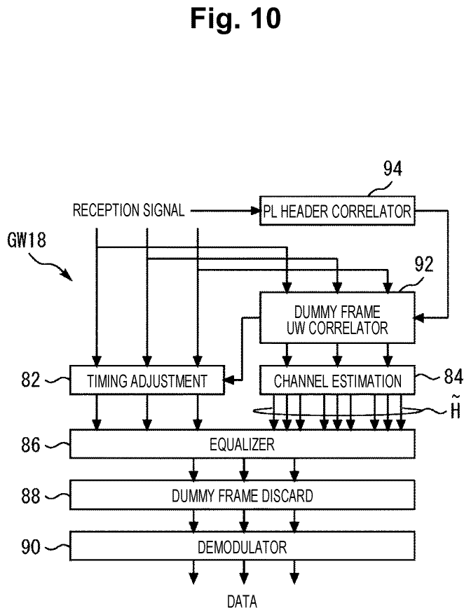

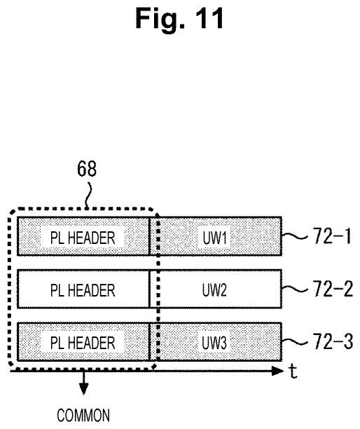

Next, a second embodiment of the present disclosure will be described with reference to FIGS. 10 and 11.

A wireless communication system of the second embodiment of the present disclosure is similar to that of the first embodiment except that the internal structure on the reception station side is changed from the structure illustrated in FIG. 7 to the structure illustrated in FIG. 10. Hereinafter, description will be given focusing on a portion specific to the wireless communication system of the present embodiment.

In the configuration illustrated in FIG. 10, the dummy frame UW correlator 80 illustrated in FIG. 7 is replaced with a dummy frame UW correlator 92. In addition, in the configuration illustrated in FIG. 10, a PL header correlator 94 is added to the configuration illustrated in FIG. 7. The configuration illustrated in FIG. 10 is similar to the configuration illustrated in FIG. 7 except for the above two points.

### [Feature of Second Embodiment]

FIG. 11 is a diagram for describing a problem included in the wireless communication system of the first embodiment. More specifically, FIG. 11 illustrates three dummy frames 72-1 to 72-3 simultaneously transmitted from three antennas 12 included in an MS 16.

UW1 to UW3 unique to the sending antennas 12 are respectively given to the dummy frames 72-1 to 72-3. Since these include orthogonal codes, even when the three dummy frames 72-1 to 72-3 are simultaneously sent, they can be controlled to a combination of 1 and 0 as for in a mutual relationship. Therefore, even when a plurality of signals interferes with each other, there is no occurrence of unreasonably large intensification.

On the other hand, since a PL header 68 needs to include a prescribed symbol indicating a dummy, all the dummy frames 72-1 to 72-3 are the same. For this reason, when they are simultaneously sent, a plurality of signals may intensify each other due to the phase relationship, and the reception power may locally become an excessive value.

When the reception signal including the reception power that is excessive even locally is directly input to the correlator, an error occurs in the peak detection processing, and a situation in which UW1 to UW3 cannot be correctly detected may occur. Therefore, in order to correctly extract UW 76 and control information 78 included in the dummy frames 72, it is desirable not to input a reception signal involving excessive power to the correlator that performs peak detection.

The PL header correlator 94 included in the GW 18 illustrated in FIG. 10 receives reception signals from the plurality of ground antennas 14 and detects the correlation state of the PL header included in the simultaneously received signals. Then, in a case where mutual intensification exceeding the threshold is recognized in the PL header, it is determined that excessive overlap of the dummy frames 72 occurs, and a Disable signal is output to the dummy frame UW correlator 92. On the other hand, the PL header correlator 94 outputs an Enable signal toward the dummy frame UW correlator 92 in a case where intensification exceeding the threshold is not recognized in the PL header.

In addition, the dummy frame UW correlator 92 in the present embodiment stops receiving the reception signal when the Disable signal is input, and advances the peak detection processing only in a case where the Enable signal is input. Therefore, in the present embodiment, the dummy frame UW correlator 92 performs peak detection only in a situation where the plurality of reception signals does not excessively intensify each other and the UW 76 can be correctly detected. As a result, according to the present embodiment, it is possible to prevent erroneous detection of the UW 76 and the like, and to achieve higher quality MIMO transmission than the case of the first embodiment.

### [Modification of First and Second Embodiments]

Meanwhile, in the first and second embodiments described above, the LEO satellite and the HAPS are exemplified as the MS 16, but the MS 16 is not limited thereto. As long as the processing capability is involved, a wireless communication device that moves on the ground, such as a mobile terminal, may be used as the MS 16.

Reference Signs List

| | |
|---|---|
| 10 | Satellite |
| 12, 12-1 to 12-3 | Antenna |
| 14, 14-1 to 14-3 | Ground antenna |
| 16 | Mobile station (MS) |
| 18 | Ground station (GW) |
| 20 | Internet line |
| 66 | PL frame |
| 68 | PL header |
| 70 | Payload |
| 72, 72-1 to 72-3 | Dummy frame |
| 74 | Normal frame |
| 76 | UW |
| 78 | Control information |
| 80, 92 | Dummy frame UW correlator |
| 82 | Timing adjuster |
| 84 | Channel estimator |
| 86 | Equalizer |
| 88 | Dummy frame discarder |
| 90 | Demodulator |
| 94 | PL header correlator |

1. A wireless communication system in which a transmission station and a reception station perform spatial multiplexing transmission of a plurality of signals, wherein
the transmission station is configured to execute:
transmitting a dummy signal not including data to be transmitted by the wireless communication system;
imparting different unique information to each of dummy signals transmitted as each of said plurality of signals; and
repeatedly transmitting the dummy signal, and wherein the reception station is configured to execute:
receiving said plurality of signals;
extracting the unique information included in the dummy signal from a reception signal; and
acquiring reception information of each of said plurality of signals transmitted and received by the spatial multiplexing transmission based on the extracted unique information.

2. The wireless communication system according to claim 1,
wherein the unique information imparted to each of the dummy signals transmitted as each of said plurality of signals includes orthogonal codes having an orthogonal relationship with each other, and
the extracting of the unique information by the reception station includes acquiring reception characteristics of said plurality of signals subjected to spatial multiplexing transmission by calculating cross-correlation between the dummy signal included in the reception signal and the orthogonal code acquired in advance.

3. The wireless communication system according to claim 1, wherein
the dummy signal is a dummy signal supported by a standardized communication scheme adopted by the wireless communication system, and
the unique information is imparted to the dummy signal within a range not impairing a function of the communication scheme achieved by the dummy signal in demodulation performed by the reception station under the standardized communication scheme.

4. The wireless communication system according to claim 3, wherein
the dummy signals supported by the standardized communication scheme have common information, and
in receiving the dummy signal subjected to the spatial multiplexing transmission, with respect to a reception amplitude that rises due to overlapping of sections having the common information, the reception station is configured to further execute;
determining whether or not intensification exceeding a threshold occurs in the reception amplitude;
disabling reception of the dummy signal when it is determined that the intensification has occurred; and
enabling reception of the dummy signal when it is determined that the intensification has not occurred.

5. The wireless communication system according to claim 1, wherein
the transmission station is configured to transmit a normal signal including data to be transmitted by the wireless communication system following the dummy signal, and
the reception station is configured to read the data included in the normal signal by performing equalization on the normal signal based on the reception information derived from the dummy signal received immediately before the normal signal.

6. A wireless communication device comprising a function of a transmission station and a function of a reception station and performing spatial multiplexing transmission of a plurality of signals with respect to a communication destination wireless communication device, wherein
the transmission station is configured to execute:
transmitting a dummy signal not including data needed to be transmitted beyond the communication destination wireless communication device;
imparting different unique information to each of dummy signals transmitted as each of said plurality of signals, and
repeatedly transmitting the dummy signal, and wherein
the reception station is configured to execute
receiving said plurality of signals transmitted from the communication destination wireless communication device by spatial multiplexing transmission,
extracting the unique information included in the dummy signal from a reception signal, and
acquiring reception information of each of said plurality of signals transmitted and received by the spatial multiplexing transmission based on the extracted unique information.

7. A wireless communication method for a transmission station and a reception station to perform spatial multiplexing transmission of a plurality of signals, the wireless communication method comprising:
by the transmission station,
transmitting a dummy signal not including data needed to be transmitted beyond the reception station;
imparting different unique information to each of dummy signals transmitted as each of said plurality of signals; and
repeatedly transmitting the dummy signal, and
by the reception station,
receiving said plurality of signals,
extracting the unique information included in the dummy signal from a reception signal, and
acquiring reception information of each of said plurality of signals transmitted and received by the spatial multiplexing transmission based on the extracted unique information.

8. A computer readable storage medium storing a wireless communication program for causing a wireless communication device including a function of a transmission station and a function of a reception station to perform the wireless communication method according to claim 7.
